(19) United States
(12) Patent Application Publication
(10) Pub. No.: US 2004/0253408 A1
(43) Pub. Date: Dec. 16, 2004

(54) Variable optical effect textile

(75) Inventor: Robert D. Hutchison, Daleville, VA (US)

Correspondence Address: NIXON & VANDERHYE, PC, 1100 N GLEBE ROAD, 8TH FLOOR, ARLINGTON, VA, 22201-4714, US

(73) Assignee: BURLINGTON INDUSTRIES, INC., Greensboro, NC

(21) Appl. No.: 10/459,722

(22) Filed: Jun. 12, 2003

(51) Int. Cl. B32B 3/02; B32B 33/00

(52) U.S. Cl. 428/89; 428/88

(57) ABSTRACT

The textile includes a plurality of raised ribs laterally spaced one from the other and straddling textile yarns between the raised ribs. A yarn strand of a color different than the color of the raised ribs and straddled fibers extends directly along one side of the raised ribs and a yarn strand of a different color extends along an opposite side of the raised ribs. Depending upon the perspective of the viewer of the textile surface, the color of one of the yarn strands is hidden from view, while the color of the other yarn strand is observable, rendering different optical effects (textile colors) to the viewer as a function of the viewer's perspective.

### BACKGROUND OF THE INVENTION

The present invention relates to a textile having a surface with a variable optical effect and particularly relates to a carpet, in roll or tile form, having a carpet surface which produces an apparent change in the surface color of the carpet as a function of the observer's perspective.

Many and different types of surface effects have been produced in textiles, including carpets. For example, carpets having surface portions of variable height oftentimes produce pleasing aesthetic characteristics. For example, Demey, U.S. Pat. No. 6,367,514 discloses a woven carpet which provides boucle, velvet or high loop effects, and which effects can be altered to provide design and color variations. In U.S. Pat. No. 4,000,707, tufted pile fabric is provided having visually distinct pile areas which present different color and pattern effects in longitudinal and transverse directions in a carpet. At least two differently colored yarns are alternately ranged in the rows of tufts, and the pile areas include a first area wherein one of the yarns is substantially concealed, a second pile area wherein the other of the yarns is substantially concealed and then a third pile area wherein both yarns are substantially equally visible. A leaf pattern having veins of contrasting colors is disclosed in a pile fabric in U.S. Pat. No. 2,699,593. Mixed yarns of synthetic polymer of different colors are formed in various patterns and afford optical effects in U.S. Pat. No. 3,899,562. None of these carpets or textiles, as disclosed in these patents, provide a textile or carpet in which the color of the carpet appears to change as the carpet is viewed from different perspectives.

### BRIEF DESCRIPTION OF THE INVENTION

In accordance with a preferred embodiment of the present invention, a textile, for example, a carpet, is provided with a textile surface which appears to change color depending upon the perspective of the viewer. To accomplish this apparent change in color, textile structure, texture and color are used to create a particular geometry which affects the color of the textile the viewer sees from different perspectives. In an illustrative embodiment of the present invention, the structure of the textile preferably includes a plurality of laterally spaced, elongated repetitive ribs of yarns raised from a level yarn surface. The ribs are prominent and formed deliberately bulky above the level surfaces straddled by the ribs and are bold in both visual effect and construction. Preferably, the raised ribs and level surfaces are formed of yarn loops tufted into a substrate to form high and low pile surfaces. At the level surfaces below the upper ends of the ribs and directly adjacent the bases of the ribs, one or more yarn strands of a different color than the ribs are inserted and preferably lie coextensive with the ribs. The differently colored yarn strands may be provided repetitively on one or both sides of the ribs.

When the textile surface is viewed from different perspectives, the surface will appear to change from the color of the rib to the color of the yarn strands, and vice versa, depending upon the perspective of the viewer. For example, the yarn strands provided on only one side of the ribs may be red. The yarns of the raised ribs and level surfaces therebetween may be black. When the textile is viewed from one side of the rib, the viewer will see the color of the yarn strand(s) and the raised ribs. The red-colored yarn strands are repetitive from the side from which the textile surface is viewed. At acute angles, the carpet appears as ribbons of black and red. As the viewer's perspective decreases, i.e., the acute angle diminishes toward the textile surface, the black of the ribs appears to diminish and the red color becomes dominant so that the viewer sees an essentially all red carpet. However, when an individual views the carpet from the opposite side of the rib, the red yarn strands are hidden from view by the raised ribs and the carpet appears as the color of the upstanding ribs, e.g., black.

In a further embodiment, the opposite side of each of the ribs is provided with yarn strand(s) of a different color than the first yarn strand and the color of the ribs. For example, a second yarn strand of a contrasting color relative to the first yarn strand, such as silver, is inserted into the textile below the upper ends of each of the ribs and directly adjacent the ribs on sides thereof opposite the red yarn strand(s). Depending upon the perspective of the viewer, the textile surface, as viewed from the opposite side, will appear to comprise ribbons of black and silver in color. As the viewer's perspective decreases toward the carpet surface, the apparent color of the textile will change from ribbons of black and silver, to predominantly silver. As the viewer's perspective reverses to positions above the surface and beyond, the viewer will see ribbons of black, red and silver, changing to ribbons of black and red and then finally to the color of the first yarn strand, i.e., red, and vice versa. It will be appreciated that the optical effect of the present textile is particularly useful in carpets applied in large open areas such as retail stores or airports. An individual passing through such large area, e.g., in a meandering manner, will see an apparent variation in the color of the carpet. Thus, there is an illusion of color change in the carpet when, in fact, there is no change in the construction of the carpet.

In a preferred embodiment according to the present invention, there is provided a textile, comprising a substrate, a textile pile surface carried by the substrate having a longitudinally extending first surface portion raised from an adjacent second surface portion and at least one yarn strand in the pile surface on one side of and coextensive with the first surface portion at an elevation below an upper end of the pile surface of the first surface portion, the yarn strand having a different color than the color of the first surface portion, enabling an individual viewing the textile from the one side to view the colors of the yarn strand and first surface portion and, from the opposite side, to view the color of the first surface portion without viewing the color of the yarn strand, thereby creating the appearance of a change in the color of the textile surface upon a change in viewing perspective.

In a further preferred embodiment according to the present invention, there is provided a carpet comprising a substrate, a carpet face including elongated first and second surface portions formed of first and second yarns, respectively, with the first surface portions being elevated above the second surface portions, the first yarns of the first surface portions forming a plurality of longitudinally extending laterally spaced ribs, the second yarns of the second surface portions being disposed between the ribs and a plurality of elongated yarn strands formed in the carpet face, with at least one yarn strand thereof disposed on one side of each rib at an elevation below the upper end of the rib, the yarn strands having a different color than the color of the yarns of the ribs, enabling an individual viewing the carpet from the one side to view the colors of the yarn strands and the ribs and, from the opposite side, to view the color of the ribs without viewing the color of the yarn strands, thereby creating the appearance of a change in the color of the carpet surface upon a change in viewing perspective.

### BRIEF DESCRIPTION OF THE DRAWINGS

FIG. 1 is a fragmentary schematic plan view of a textile illustrating a preferred embodiment of an optical effect carpet according to the present invention;

FIGS. 2A and 2B are perspective views thereof taken at respective acute angles from opposite sides of the textile; and

FIG. 3 is a schematic cross-sectional view taken generally about on line 3-3 in FIG. 1.

### DETAILED DESCRIPTION OF THE INVENTION

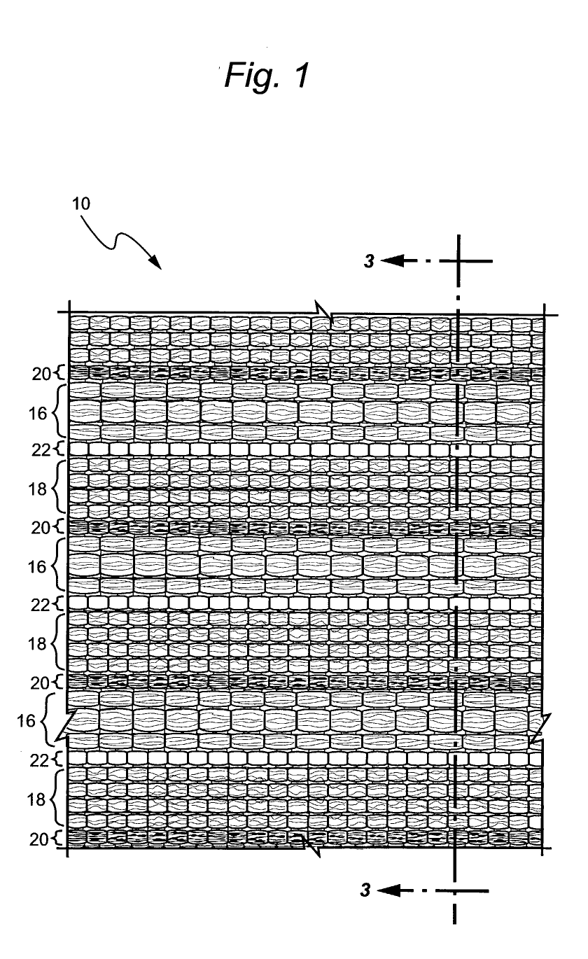

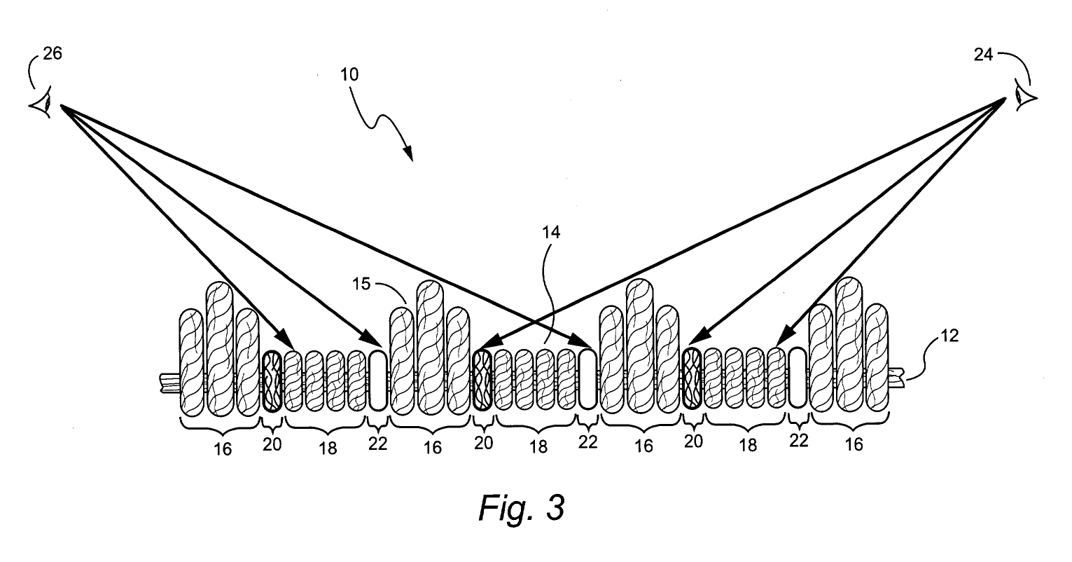

Referring now to the drawings, particularly to FIG. 1, there is illustrated a textile product, generally designated 10, which may comprise wall or ceiling coverings, a floor covering such as a carpet, and which may be provided in roll or tile form, upholstery fabrics, panel fabrics for commercial interiors, interior fabrics/carpets for trains, planes or boats, as well as headliner, seating material and floor mats for automobiles. Referring to FIG. 3, the textile product may include a substrate 12 to which the textile fibers which form the visual or wear surface 14 of the textile are secured. The textile fibers which form the viewable or wear surface 14 may, for example, comprise tufted loops forming a tufted loop pile surface or a cut loop tufted pile surface.

In accordance with a preferred embodiment of the present invention, texture and color of the textile surface 14, e.g., the tufted loop pile surfaces 14, is utilized to create a geometry which changes the perceived color of the textile surface when viewed by an individual depending upon the individual's perspective relative to the surface. In the illustrative preferred embodiment, the textile includes a first surface portion 15 comprised of a plurality of elongated raised ribs 16 laterally spaced one from the other and formed of the tufted fibers. The raised ribs 16 are repetitive throughout the surface of the textile, as indicated in FIG. 1. Thus, the ribs 16 are raised relative to the textile fibers forming the adjoining or second textile surface portions 18 between the raised ribs 16. The fibers forming the ribs 16 are intentionally bulky to form bold and prominent ribs readily apparent and viewable on the textile surface and at elevations raised above the second surface portions 18.

Intermediate adjacent raised ribs 16 are a plurality of fibers forming the second textile surface portion 18. These portions 18 may similarly form a tufted loop or tufted cut loop pile surface. In the preferred tufted loop embodiment, the loops of the surface portion 18 are tightly drawn in the substrate 12 such that those fiber loops and hence surface portion 18 lie at an elevation substantially below the elevation of surface portion 15 and the elevated ends of tips of ribs 16. While FIGS. 1 and 3 illustrate three or four longitudinally extending rows of fibers forming first surface portions 15 of ribs 16 and three longitudinally extending rows of fibers forming the intermediate surface portions 18, it will be appreciated that the number of portions 15 and 18 may be increased or decreased as desired for any particular textile surface design.

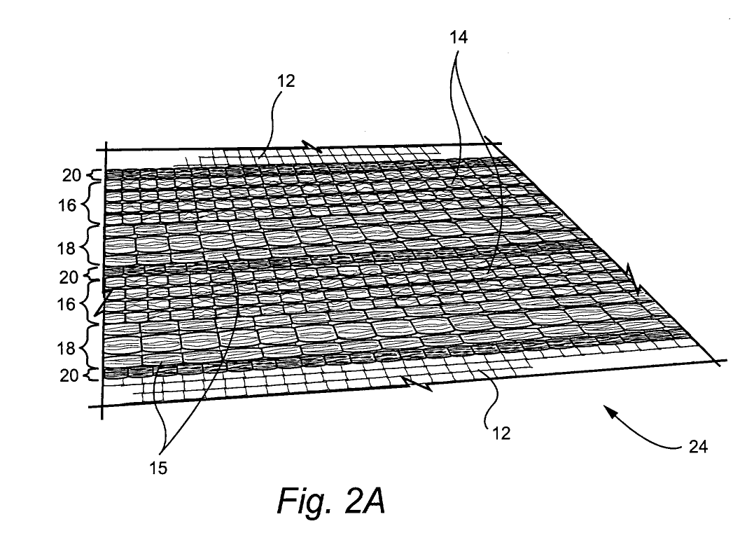

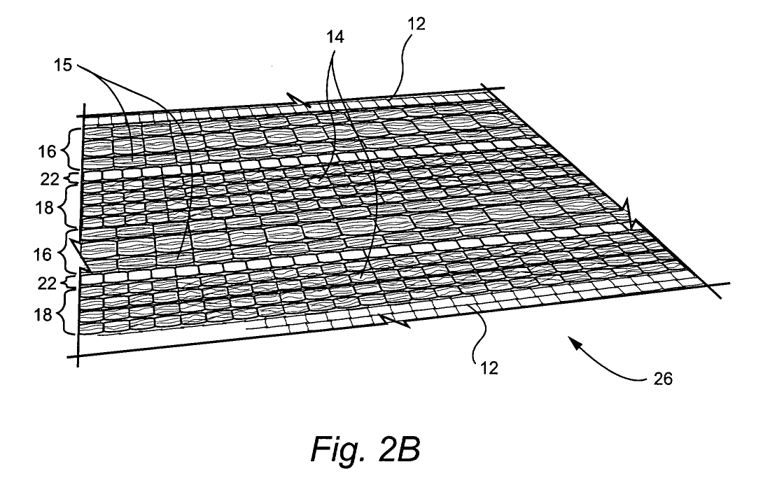

To provide the perceived color-changing visual effect, one or more yarn strands, for example, strand 20, is inserted during the manufacturing process along one side of the first raised portions 15, e.g., ribs 16. For example, as illustrated in FIG. 3, yarn strand 20 is located in the substrate 12 directly to one side of, e.g., just to the right of each of the ribs 16 as illustrated in FIG. 2. The yarn strand 20 is preferably a different color than the fibers forming the portions 15 and 18. For example, the yarn strand 20 may be red, while the fibers of portions 15 and 18 may be black. Also, multi-color space dyed yarns may be used as the color accent strand 20. By locating the yarn strands 20 directly adjacent one side of the ribs 16, yarn strands 20 will be viewed or not, depending upon the perspective of the individual viewing the surface of the textile. For example, an individual viewing the textile from perspective 24 (FIGS. 3 and 2A) on the right side of the textile surface as seen in FIG. 3 will see the red yarn strands 20, as well as the black yarn strands forming portions 15 and 18. Consequently, the textile surface, viewed from that perspective, appears as a series of black and red stripes or ribbons. As the perspective 24 forms a sharper angle with the textile surface, the red color of the yarn strands 20 will tend to dominate the visual appearance of the textile with diminishing contribution of the black fibers to the perceived color of the textile surface. At very sharp acute angles from perspective 24, the surface will appear as predominantly red. If the observer, however, is on the left side of the textile at perspective 26 (FIGS. 3 and 2B), the raised ribs 16 of portions 15 will prevent the viewer from seeing the red yarn strands 20. Consequently, the viewer from perspective 26 sees only a textile surface of one color, e.g., black (ignoring for present purposes the other yarn strand 22 discussed below). Thus, depending upon the perspective of the individual viewing the textile surface, the textile surfaces as viewed from one perspective 26 (ignoring the strand 22) may appear totally black. As perspective 26 moves toward perspective 24, the surface may appear as black and red stripes. As perspective 26 changes to perspective 24 and becomes sharper, the surface may appear as predominantly red. The boldness, prominence and bulk of the ribs 16 essentially hides the red fiber yarn strand 20 when viewed from perspective 26 and, because of the repetitiveness of the red yarn strand, the surface may appear substantially red from the opposite perspective 24.

In a further preferred form of the textile hereof, a further one or more differently colored yarn strands 22 is disposed in the textile surface. One or more yarn strands 22, as illustrated in FIGS. 1 and 3, are disposed on the opposite side of each of the raised portions 15 of ribs 16 from the side on which the yarn strand(s) 20 is disposed. Like yarn strands 20, yarn strands 22 are tufted into the substrate 12 directly laterally adjacent and preferably coextensive with the raised portions 15 of ribs 16. The yarn strand(s) 22, however, may be of an entirely different color than either one or both of the ribs 16 and the yarn strand(s)

20. For example, yarn strand(s) 22 may be silver in color. Given the texture of the textile and the location of the yarn strand(s) 22, it will be appreciated that from perspective 24, the silver yarn strands 22 cannot be viewed. Consequently, the appearance of the textile to the observer at perspective 24 is that of a textile surface comprised of a series of black and red stripes with the red color dominating as the perspective 24 moves progressively closer to a sharper angle relative to the textile surface. Thus, the silver yarn strands 22 are not visible from perspective 24.

On the other hand, from perspective 26, the red yarn strands 20 are not visible. However, the silver yarn strands 22 are visible. Consequently, from perspective 26, the observer sees a textile surface comprised of a series of black and silver stripes, with the color silver dominating as the perspective 26 moves to a sharper angle vis-a-vis the textile surface 14. Consequently, from perspective 24, the textile surface appears as a series of red and black stripes, with the color red dominating as the perspective 24 forms a sharper angle with the textile surface whereas from perspective 26, the textile surface appears as a series of black and silver stripes, with the color silver dominating as perspective 26 moves to a sharper angle with the textile surface 14.

The foregoing apparent change in color can be readily ascertained from a comparison of FIGS. 2A and 2B. In FIG. 2A, the view is from perspective 24. The red yarn strand 20 is therefore visible and the silver yarn strand 22 is not visible. The observer sees only the black color of the ribs 16 and second surface portions 18, together with the red colored strands 20. In FIG. 2B, the view is from perspective 26. Thus, the red yarn strand(s) 20 are hidden from view and the silver yarn strand(s) 22 is visible. Thus, the observer sees only the black color of the ribs 16 and the second surface portions 18, together with the silver colored strands 22.

Still further, as viewed from a perspective substantially intermediate perspectives 24 and 26, for example, medially thereof, the textile surface would appear to have a series of black, red and silver stripes, which afford a further distinct visual appearance. Where the textile is provided as roll carpet or tiles and laid in large, open public spaces such as retail stores or airports, the carpet will appear to change color from red to silver with a mix of colors of red, black and silver as a function of the viewer's perspective. Thus, the optical effect changes as a function of the relative perspective of the viewer and the surface of the textile.

It will be appreciated that the colors identified above in the textile are considered as representative only and that other and different colors and different arrangements of the colors including non-repetitive colors may be provided in the textile. Additionally, the raised portions 16 need not extend linearly in the carpet but could meander throughout the textile in random or non-patterned forms, with the yarn strands meandering with the raised portions 15, affording different visual effects dependent upon the perspective of the viewer. Also, if the textile is provided in carpet tile form, the tiles can be arranged with the tufted fibers of adjacent carpet tiles running either parallel or perpendicular to one another, offering still further optical effects of apparent changes in color.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A textile, comprising:
a substrate;
a textile pile surface carried by said substrate having a longitudinally extending first surface portion raised from an adjacent second surface portion; and
at least one yarn strand in said pile surface on one side of and coextensive with said first surface portion at an elevation below an upper end of the pile surface of said first surface portion, said yarn strand having a different color than the color of the first surface portion, enabling an individual viewing the textile from said one side to view the colors of the yarn strand and first surface portion and, from the opposite side, to view the color of the first surface portion without viewing the color of the yarn strand, thereby creating the appearance of a change in the color of the textile surface upon a change in viewing perspective.

2. A textile according to claim 1 wherein the first and second surface portions comprise yarns tufted through the substrate.

3. A textile according to claim 1 wherein said yarn strand extends along one side of said first surface portion at an elevation generally corresponding to the elevation of said second surface portion.

4. A textile according to claim 1 wherein said first surface portion has a texture greater than a texture of the second surface portion.

5. A textile according to claim 1 including at least a second yarn strand in said pile surface on an opposite side of and coextensive with said first surface portion at an elevation below an upper end of the pile surface of said first surface portion, said second yarn strand having a different color than said first yarn strand and said first surface portion, enabling the individual viewing the textile from said opposite side to view the colors of the second yarn strand and the first surface portion without viewing the color of the one yarn strand, and from the one side to view the colors of the first-mentioned yarn strand and first surface portion without viewing the color of the second yarn strand.

6. A textile according to claim 5 wherein said second yarn strand extends along said one side of said first surface portion at an elevation generally corresponding to the elevation of the pile surface of said second surface portion.

7. A textile according to claim 5 wherein said first surface portion has a texture greater than a texture of the second surface portion.

8. A carpet comprising:
a substrate;
a carpet face including elongated first and second surface portions formed of first and second yarns, respectively, with said first surface portions being elevated above the second surface portions;
the first yarns of said first surface portions forming a plurality of longitudinally extending laterally spaced ribs, the second yarns of said second surface portions being disposed between said ribs; and
a plurality of elongated yarn strands formed in the carpet face, with at least one yarn strand thereof disposed on one side of each said rib at an elevation below the upper end of said rib, said yarn strands having a different color than the color of the yarns of the ribs, enabling an individual viewing the carpet from the one side to view the colors of the yarn strands and the ribs and, from the opposite side, to view the color of the ribs without viewing the color of the yarn strands, thereby creating the appearance of a change in the color of the carpet surface upon a change in viewing perspective.

9. A carpet according to claim 8 wherein the yarns are tufted through the substrate and the carpet face includes one of a tufted loop or cut loop pile.

10. A carpet according to claim 8 wherein said yarn strand extends along one side of said first surface portion at an elevation generally corresponding to the elevation of said second surface portion.

11. A carpet according to claim 8 wherein said first surface portion has a texture greater than a texture of the second surface portion.

12. A carpet according to claim 8 including at least a second yarn strand in said carpet face on an opposite side of and coextensive with said first surface portion at an elevation below an upper end of said first surface portion, said second yarn strand having a different color than the colors of said first yarn strand and said first surface portion, enabling the individual viewing the carpet from said opposite side to view the colors of the second yarn strand and the first surface portion without viewing the color of the one yarn strand, and from the one side to view the colors of the one yarn strand and first surface portion without viewing the color of the second yarn strand.

13. A carpet according to claim 12 wherein said second yarn strand extends along said one side of said first surface portion at an elevation generally corresponding to the elevation of said second surface portion.

14. A carpet according to claim 12 wherein said first surface portion has a texture greater than a texture of the second surface portion.
